(19) United States
(12) Patent Application Publication
(10) Pub. No.: US 2026/0281706 A1
(43) Pub. Date: Sep. 17, 2026

(54) WIRELESS SYSTEM MEASUREMENT COLLECTION FOR ARTIFICIAL INTELLIGENCE USE CASES

(71) Applicant: APPLE INC., Cupertino, CA (US)

(72) Inventors: Weidong Yang, San Diego, CA (US); Dawei Zhang, Saratoga, CA (US); Huaning Niu, San Jose, CA (US); Wei Zeng, San Diego, CA (US); Oghenekome Oteri, San Diego, CA (US); Chunxuan Ye, San Diego, CA (US); Sigen Ye, San Diego, CA (US)

(21) Appl. No.: 19/168,563

(22) PCT Filed: May 10, 2024
(86) PCT No.: PCT/US2024/028748

§ 371 Date: Sep. 24, 2025

Related U.S. Application Data
(60) Provisional application No. 63/501,919, filed on May 12, 2023.

(51) Int. Cl. H04W 8/24; H04W 24/10

(52) U.S. Cl. CPC H04W 8/24; H04W 24/10

(57) ABSTRACT

A UE may send a UE capability report to a network node. The UE capability report may indicate that the UE supports logged data collection for artificial intelligence (AI) training. The network node may send the UE a data collection request. The UE may verify data collector credentials of a data collection server corresponding to the network node. The UE may send logged data to the network node in a batch with other additional data samples collected at a different time than the measurements and the related information.

### TECHNICAL FIELD

This application relates generally to wireless communication systems, including generating logged measurements for artificial intelligence model training.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table comparing immediate AI-data-collection framework, and a logged AI-data-collection framework in accordance with some embodiments.

FIG. 2 illustrates a signal flow diagram for logged data collection framework in accordance with some embodiments.

FIG. 3 illustrates a first set of coupled reports and a second set of coupled reports 304 in accordance with some embodiments.

FIG. 4A illustrates a codebook configuration information element.

FIG. 4B illustrates a CSI reporting configuration.

FIG. 5 illustrates a flowchart of a method for a UE, according to embodiments herein.

FIG. 6 illustrates a flow chart of a method for a network node, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

The goals of wireless communication systems include providing reliable, efficient, and secure communication between UEs and network nodes. Artificial intelligence (AI) may be used to assist in meeting these goals. For example, AI technologies can be used in several ways within a wireless system, including network optimization. For instance, AI can be used to optimize the performance of the network by analyzing data, predicting future traffic patterns, and identifying areas of congestion. This can help to improve network efficiency and reduce downtime. Further, AI can be used to automate network operations, such as provisioning, configuration, and optimization. This can help to reduce costs and improve operational efficiency.

Three example use cases where AI may be used to improve a networks operation include Channel State Information (CSI) feedback, beam management (BM), and positioning. For example, for BM, an AI model may be used to select a beam based on a subset of beam measurements. For CSI feedback, the AI model may reduce overhead. For positioning, the AI model may be able to be able to estimate position more accurately.

To generate an AI model, a system may collect data and the collected data may be used to train an AI model. The model may then be used to improve performance of the system. Data collection can be used for model training, feedback from the UE for the model, and monitoring of the model.

An AI model uses training data to enhance its performance. Such data may already be collected by the UE. For example, for beam management (e.g., time domain prediction), there may be several scenarios where a UE may report the beam measurement to the network. Similarly, during data collection for AI model training, the UE also reports the measurements to the network if network side training is used. For AI-CSI and AI-positioning, data collection may be needed.

An instance where measurement data is collected is for radio measurement collection for Minimization of Drive Tests (MDT). For MDT data two modes of data logging are captured: immediate MDT and logged MDT. For logged MDT the network may set up certain conditions, such as a UE failure, for the UE to log the data. When such a condition occurs, the UE may record the data then upload the data to the network later. The network may use that information to optimize.

For AI model training, the framework of MDT can be leveraged. However, there are a number of issues to address specifically relating to AI. A first problem may be that, for the beam management use case, when Set B is not a subset of Set A, how can a network ensure data collection for Set A and Set B is conducted at the same time? For example, for input data and output data of the AI model, how can a network enforce correlation or dependence among their collections. A second problem may be how the collection of data can be controlled. There may be a large amount of data that the UE can provide, but it may be advantageous to reduce the amount of data for efficient operation of a radio network and/or UE power saving. For instance, the network may limit the data to measurements that occur at a target Reference Signal Received Power (RSRP). A third problem is that for MDT, much of the collected information about the UE may pose a threat to UE privacy. For example, the information about the UE may include geographical scope of measurement logging. It is possible to configure the geographical area where the defined set of measurements may be collected. The information may also include location information. The measurements may be linked to available location information and/or other information or measurements that can be used to derive location information. The information may also include time information. The measurements in measurement logs may be linked to a time stamp. The information may also include sensor information. The measurements can be linked to available sensor information that can be used to derive UE orientation in a global coordinate system, the uncompensated barometric pressure and the UE speed.

Accordingly, there is a need for an AI-data-collection framework. The AI-data-collection framework may either be immediate or logged for data collection. For example, similar to immediate MDT, the data collection can be conducted in a piece-wise way. For instance, the network may leverage the CSI reporting, beam management reporting, and positioning report, and even though any of those reports may not be of use to the UE's operation per se, the UE can be instructed to perform the measurement and reporting. Such a practice can be designated as an immediate AI-data-collection framework.

Similar to logged MDT, the data collection for the AI model training can be conducted in a batch fashion. For example, a UE can be instructed to collect many data samples, and upload to the network at suitable time. This approach can be designated as a logged AI-data-collection framework. This approach, may support the fair use of data collection. As training data is key for AI, training data's collection relies on UE vendor and end user's cooperation, AI's success should be shared by UE vendor and end user. The data collection condition, the UE capability for data collection, and the upload of data can also be considered.

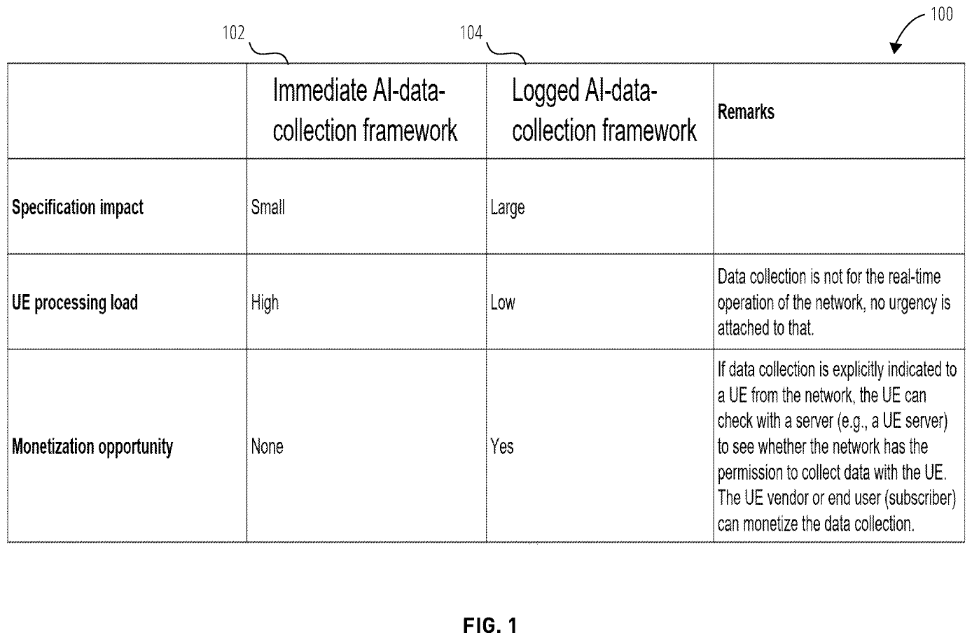

FIG. 1 illustrates a table 100 comparing immediate AI-data-collection framework 102, and a logged AI-data-collection framework 104 in accordance with some embodiments. Immediate AI-data-collection framework 102 may have a small impact on the specification because it may be able to leverage the current CSI/BM/positioning measurement/report framework. However, the UE processing load for data collection may be high even though data collection may not be for real-time operation of network. Further, since data collection in this case is masqueraded as for regular radio network's operation, the UE simply follows measurement instructions from the network without any awareness of the true intention behind the instructions, there may not be a monetization opportunity for either UE vendor or end user.

In contrast to the case where CSI/BM/positioning measurement and reporting as in the current New Radio (NR) design are used for data collection purposes (immediate AI-data-collection framework), the logged AI-data-collection framework 104 may allow a relaxed processing time and reporting time, and it offers the opportunity for monetization of the data collection. Further, if data collection is explicitly indicated to a UE from the network, the UE can check with a server (e.g., a UE server) to see whether the network has the permission to collect data with the UE. The UE vendor or end user (subscriber) can monetize the data collection.

As learned from the recent success of AI, training data is key for AI. As it is difficult to differentiate data collection with regular radio network's operation, with the immediate AI-data-collection framework 102 the network may collect data through UEs without providing any tangible benefit to the UE vendor or the UE owner.

With the logged AI-data collection framework 104, consent of data collection may have to be in place for data collection. The establishment of consent may be from one or multiple agreements among the UE vendor/UE owner and the network vendors and operators. For that purpose, a new network signaling protocol may be introduced for the data collector to provide its credentials to a UE. Upon verification of the credentials, the UE may consent to a data collection request, and the end user (UE owner), UE vendor, etc. may participate in the success of any AI use.

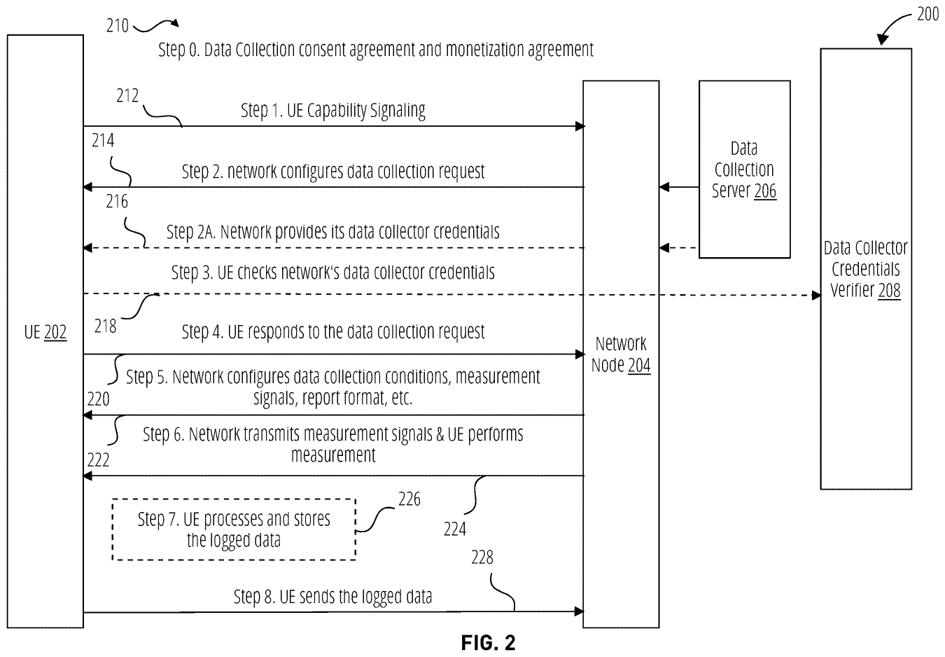

FIG. 2 illustrates a signal flow diagram 200 for logged data collection framework in accordance with some embodiments. In step 0, the UE vendor or end user may sign a data collection agreement 210 with infra-vendor, operator, third party data collector (e.g., which provides data collection service to infra-vendor or operator), and the agreement can include monetization terms. For example, the UE 202 may provide up to 10,000 data samples per month, and for every triggered collection of data sample, 1 cent may be paid.

In some embodiments, the UE 202 can directly verify the credentials of the data collector. For example, some token can be provisioned periodically or aperiodically to the UE 202 (e.g., every 1 hour) through an application installed on a phone, consequently multiple such applications or instances of token provisioning may be used. (e.g., one for each vendor). To avoid direct interaction with the data collector (e.g., infra-vendor/operator/third party data collector), the verification of data collector credentials can go through a central entity (e.g., data collector credentials verifier 208), with that the inquiry and response on data collector credentials can be made secure.

In the illustrated embodiment, in Step 1 (i.e., UE capability signaling 212), the UE reports its capability to support the logged AI-data collection framework to the network node 204. The capability report sent to the network node 204 may indicate support for different sub-features of the logged AI-data collection framework. The logged AI-data collection framework may include multiple sub-features, such as for CSI, BM, and positioning. In some embodiments, the UE capability signaling 212 may have even finer granularities for indicating what the UE 202 supports. For example, the UE could indicate that it supports a certain number of ports for a period of time or a number of samples (e.g., 32 Tx ports for 1k samples, 16 Tx ports over 4 time instances for 512 samples, etc).

In step 2, the network node 204 may send the UE 202 a data collection request 214. In step 2A, the network node 204 may send the UE 202 its data collector credentials 216. In Step 2 and Step 2A, the signaling flows are not necessarily in chronological order. For example, in some embodiments, Step 2A and even Step 3 may be executed before Step 2. In the illustrated embodiment, Step 2 is a signaling from the network for data collection, the originator can be a network node or another network entity.

In Step 2A, the data collector credentials 216 are provided to the UE 202. The originator of the data collector credentials 216 may be the radio network (e.g., network node 204), or the provisioning may be through higher signaling from a core network entity (e.g., data collection server 206). In some embodiments the network node 204 may receive the data collector credentials 216 from another entity (e.g., data collection server 206) and then send the data collector credentials 216 to the UE 202. The signaling itself can be encrypted so the radio network cannot modify or inspect it.

The data collector credentials 216 may contain the identity of the data collector, verification (e.g., verification in the form of a public key, a hash, etc.), a timestamp, etc. This signaling protocol may have standardization support, so phones from different vendors can contribute to the data collection.

In step 3, the UE 202 may verify 218 the provided data collector credentials 216. In some embodiments, the UE 202 may verify 218 the data collector credentials 216 with stored data collector credentials on the UE 202, or the UE may send the provided data collector credentials for verification to a data collector credentials verifier 208. In some embodiments, the verification process may be conducted locally at the UE 202 or using communication with the data collector credentials verifier 208. In some embodiments, the data collector credentials verifier 208 may not be standardized.

In Step 4, the UE 202 responds to the data collection request. The response 220 sent to the network node 204 may accept or reject the data collection request 214. The response 220 accepting or rejecting the data collection request 214 may provide benefits for scheduling. If the UE 202 did not indicate whether the data collection request 214 is rejected or accepted, the network node 204 may assume data collection is undergoing, which may affect the network's scheduling or configuration decisions, thus affecting the UE 202 or end user without any tangible benefit. On the other hand, once the network node 204 is aware that the UE 202 rejects or accepts the data collection request 214, the scheduling or configuration decision may properly take that into consideration.

In Step 5, the network node 204 may send a data collection configuration 222 to the UE to configure data collection conditions, measurement signals, report format, etc. It may be noted that Step 5 and Step 2 may be combined in some embodiments. In Step 6, the network node 204 may transmit measurement signals 224 to the UE 202, and the UE 202 may perform measurements on the transmissions from the network node 204. In Step 7, the UE 202 may perform processing on the measurements to generate the data requested by the network node 204. The UE may store 226 the logged data on the UE 202 or upload the logged data to a server.

In Step 8, if the logged data is stored on the device, the UE 202 may send 228 the logged data to the network node 204 directly. If the logged data was already uploaded to a server in Step 7, the UE may send a uniform resource locator (URL) to the network node 204. Both control plane and user plane solutions may be considered here. The logged data may be sent as a batch at a later time, in some cases with other logged data from other data collection requests.

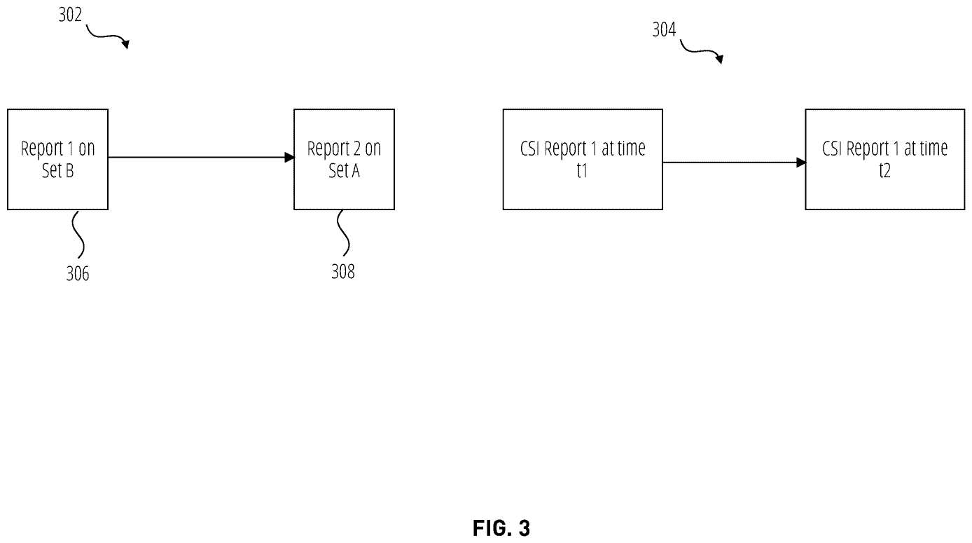

FIG. 3 illustrates a first set of coupled reports 302 and a second set of coupled reports 304 in accordance with some embodiments. For a logged AI-data-collection framework, it may be important to have correlation or dependence between two collections of logged data. Thus, the network node may configure two collections of logged data to be correlated or have dependence.

For example, when Set B 306 is a subset of Set A 308, it may be enough to configure measurement signals for a superset covering Set A 308 beams or for Set A 308 beams wherein the superset is set A itself. From the reported measurements by the UE, the network may extract the measurements for Set B 306. However, typically there may be a time gap between the measurements of beams in Set B 306 and the beams for Set A 308. When the time gap is not negligible, extracting the measurements for set B from reporting on the superset may not be possible.

When Set B 306 is not a subset of Set A 308 extracting the measurement on beams in Set B 306 from the measurement on beams in the superset may not be possible. For example, if Set B 306 consists of Synchronization Signal Block (SSB) beams but Set A 308 consists of beams associated with CSI-reference signal (RS) resources, extracting the measurement on beams in Set B 306 from the measurement on beams in the superset may not be possible.

The network may configure two coupled CSI or BM reports, for both the quasi co-location (QCL) assumption or TCI state(s) in terms of receive (Rx) spatial filter is identical but undefined by the network. For example, there may not be a source signal for the QCL chain, this may be used for connected mode UEs and idle mode UEs if the measurement resources are configured in a non-UE specific way. In some embodiments, for both reports the QCL assumption or TCI state(s) in terms of Rx spatial filter may be identical and it may be linked to a current TCI state of Physical Downlink Control Channel (PDCCH) or Physical Downlink Shared Channel (PDSCH), which may be more suitable for connected mode UEs.

For each report, the measurement resources may be SSB resources/SSB resource sets, or CSI resources/resource set(s)/resource configuration. The reports may be periodic, semi-persistent, or event-driven conditions may be defined.

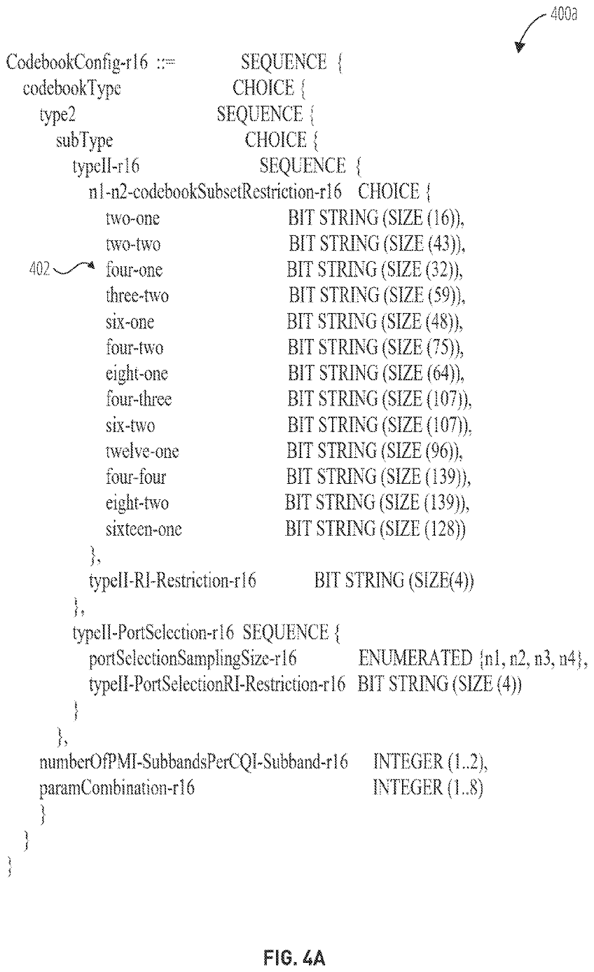

FIG. 4A illustrates a codebook configuration information element 400a. The codebook configuration information element 400a includes an antenna configuration 402 for a cell. FIG. 4B illustrates a CSI reporting configuration 400b. The antenna configuration 402 may not be known to a cell where the UE reports logged data. The UE may provide this information with the logged data.

For logged data, the data collection may not be visible to the network. This may inhibit the network from fully understanding the data for AI model training. For instance, because the logged data is measured and then reported at a later time, the network may not know the information about the cell where the data was collected if the UE does not report it. For instance, a UE may collect data in Cell 1 several hours earlier than when the logged data is reported. Then when the UE uploads the logged data, the UE may have roamed to Cell 2. Cell 2's configuration (e.g., antenna configuration) may be different from that of Cell 1. Accordingly, without the UE providing the Cell configuration information, it may be difficult for the network to properly categorize the data for training/test.

In some embodiments, for logged data, the base station antenna configuration can be provided as part of the CSI-RS resource or CSI-RS resource set. In some embodiments, the base station antenna configuration can be provided as CSI reporting as shown in FIG. 4B. Conventionally for beam management, the antenna configuration such as “eight-two” indicates the arrangement of antenna elements/modules at the base station side, including the number of rows/columns in the composition of an antenna array. There can be an order of arrangement CSI-RS according to the composition of an antenna array, for example, when DFT beams are used for CSI-RS resources' analog beamforming, the analog beam angle for a given CSI-RS resource is determined by the CSI-RS index. And to scan a 2D matrix which consists of a number of rows and a number columns, the CSI-RS indexes/analog beam angles are arranged in a row first fashion where CSI-RS index is increased from left to right on a row, and is increased from the top row to the bottom row (or from the bottom row to the top row). Alternatively the CSI-RS index is increased in a column first fashion, with possible variations.

The logged data record reported by the UE to the network node may include the antenna configuration of the cell where the measurements were taken. For example, the logged data may include “eight-two” to indicate the antenna configuration for a cell where the logged data was collected to indicate the antenna configuration. In legacy, note that the antenna configuration 402 is part of CSI reporting configuration 400b, but the UE does not report the antenna configuration back to the network. However for data collection, there may be a need for the UE to report the antenna configuration 402 along with the collected data to the network. Thus, in some embodiments, the antenna configuration can be provided to the UE by the network node in the CSI-RS resource/CSI-RS resource set or reporting configuration in the first place for beam management. Then in the logged data, the antenna configuration is reported or attached, whereby the cell or network receiving the logged data is not constrained to be the same cell or network for which the data is logged.

Further, the data available may be large, and all of the data may not be useful for the AI model trainer. For instance, the model trainer may be interested in a small subset of data for training. For logged data for AI framework, for data collection, the network may set collection conditions. For example, the network may be interested in high or low signal to noise ratios (SNRs) (e.g., SNR>=−3 dB or SNR>=−6 dB, or 5>=SNR>=0 dB, etc). The data collection conditions may be done to ensure the data collection is valid (not exceeding the UE's measurement capability), and it may also provide enough statistical points in the data collection. For logged data for AI framework, the collection may be set to start from a certain time (e.g., at rush hour (8 am) or 7 pm). For logged data for AI framework, the collection may be set to start for a certain geographical area. To ensure the quality of collected data, the Cell Global Identity (CGI) may be logged by the UE, and each data point may be associated with a timestamp. In some embodiments, a combination of collection conditions may be used.

In some embodiments, a system may age data to enhance privacy of user data. Information collected in the logged data for AI framework that may be used for the AI model training may bear privacy-sensitive information. For instance, the data may be configured for a geographical measurement logging. The data may include location information, time information and sensor information.

The threat to user privacy may be larger if the logged data is uploaded in real-time. Therefore, to address privacy concerns, in some embodiments a system may let the data “age” for a period of time (e.g., for 8 hours). This may be done so the collected information cannot be used to track a UE in real-time. For example, in Step 8 of FIG. 2 where the UE 202 sends 228 the logged data to the network, aging may occur before the logged data is sent. The logged data may be stored on the UE or on a server to age. If the logged data is uploaded to a server, the UE 202 may not need to store the logged data on its modem storage. Rather the application processor's storage may be briefly used for uploading, and the aging effect may be enforced effectively using the server's storage. For example, the UE 202 may upload data to the server after 20 minutes of logging the data, but the URL may be provided intentionally much later (e.g., after 1 hour).

Training an AI model may be improved by using data quality indication. Accordingly, in some embodiments, the UE may provide the network node with a data quality indication for the logged data. The AI model trainer may take the data quality indication into account when using or determining to use the data. For example, if the data has a low data quality indication it may be discarded, or the trainer may assign the data a lower weighting. The UE may collect data under a number of circumstances. For example, the UE may collect data for high geometry (cell center) vs low geometry (cell edge). The UE may collect data for high mobility vs low mobility. For location information, global navigation satellite system (GNSS) can be used to log the data collection's position. Whether the situation is with outside GNSS with line of sight (LoS) to GNSS satellites, or the situation is with GNSS for the urban canyon, or indoor situation with GNSS (e.g., with GNSS signal routed indoor). The reliability/accuracy of location information may be different, which may materially impact how the data is used by the model trainer (e.g., for AI-BM or AI-positioning). Accordingly, variance of measurement error, SINR, confidence level in the RSRP, may be reported by the UE.

Data collection for the AI training may occur in parallel with current measurements or it may not be tied to ongoing operations. Some embodiments determine the UE capability for data collection and UE operation for data collection. If the data collection is triggered and derived from ongoing operations of the UE that are not dedicated to data collection (e.g., whenever the RSRP arises above −90 dBm or L1-SNR goes above 5 dB for the first time (or for the first N occasions after the trigger condition)), no additional computation complexity may be involved in collecting data (e.g., RSRP measurement). The UE may include sufficient storage/memory that the UE can maintain data entries. In some embodiments, a circular buffer may be used to write to. The circular buffer may be used store data with timestamps.

However, if data collection is dedicated or not tied to an ongoing operation of the UE, then inevitably the computational complexity may need to be accounted for in some way. For example, a UE in connected mode may have two activated CCs in FR1, and no activated CCs in FR2, yet the data collection for some CCs in FR2 may be configured. Embodiments may employ different ways to account for the additional computational complexity at the UE to ensure the requested measurement and reporting won't exceed the UE capability. In some embodiments, rules are defined similar to CPU occupancy rules and memory counting rules specifically for data collection. The network node may need to ensure the configured measurement and reporting will not exceed the UE's capability. For example, if a UE reports it can measure 1024 samples of RSRPs and keep it up to 8 hours, the request from the network node should not exceed that capability. In some embodiments, a system may leverage existing CPU occupancy rules and memory count rules, and make modifications to the existing design (e.g., CSI/BM over an inactive cell).

Some embodiments herein consider a data collection framework for wireless AI. The network may provide data collector's credentials for a UE to verify, and data collection may be conditional on verification of the data collector's credentials. For AI-BM, coupled reports may be used to establish the linkage between measurement over set B and set A. In some embodiments, logged data privacy concerns may be addressed by aging data. The data collection quality may be indicated along with the logged data.

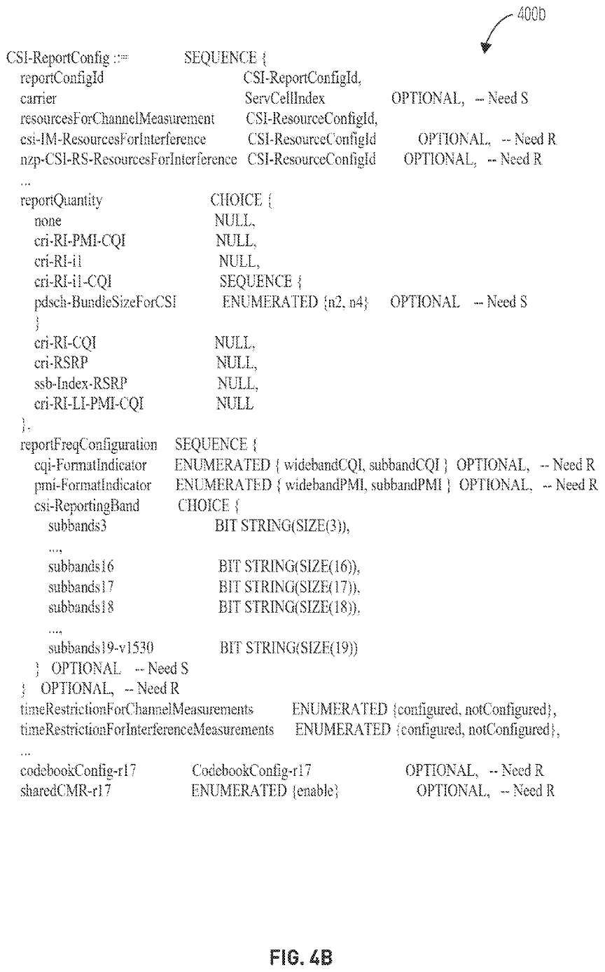

FIG. 5 illustrates a flowchart of a method 500 for a UE, according to embodiments herein. The method 500 includes sending 502 a UE capability report to a network node, the UE capability report indicating that the UE supports logged data collection for AI training. The method 500 further includes receiving 504, from the network node, a data collection request. The method 500 further includes receiving 506 data collector credentials for a data collection server corresponding to the network node. The method 500 further includes verifying 508 the data collector credentials. The method 500 further includes performing 510 measurements and collecting related information to generate logged data. The method 500 further includes sending 512 the logged data to the network node in a batch with other additional data samples collected at a different time than the measurements and the related information.

In some embodiments of the method 500, to verify the data collector credentials, the method further comprises sending the data collector credentials to a data collector credentials verifier.

In some embodiments of the method 500, the data collector credentials comprise an identity of the data collector, a verification key, and a timestamp.

In some embodiments of the method 500, the UE capability report indicates one or more sub-features that the UE supports, wherein the sub-features comprise at least one of data collection for CSI, data collection for BM, data collection for positioning, a number of ports, or a sample size.

In some embodiments, the method 500 further comprises sending, to the network node, a response to the data collection request that indicates whether the UE accepts or rejects the data collection request.

In some embodiments of the method 500, the logged data comprises coupled reports that establish linkage between measurement sets.

In some embodiments, the method 500 further comprises receiving a data collection configuration from the network node, wherein the data collection configuration includes data collection conditions indicate that the UE is to perform the measurements and collect the related information based on at least one of a signal to noise ratio, a time, or a geographical area.

In some embodiments, the method 500 further comprises sending the logged data to a server, wherein sending the logged data to the network node comprises sending a URL corresponding to a location of the logged data, wherein the URL is sent after a preconfigured amount of time has elapsed since the logged data was sent to the server.

In some embodiments, the method 500 further comprises sending a data quality indicator for the logged data.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500.

The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

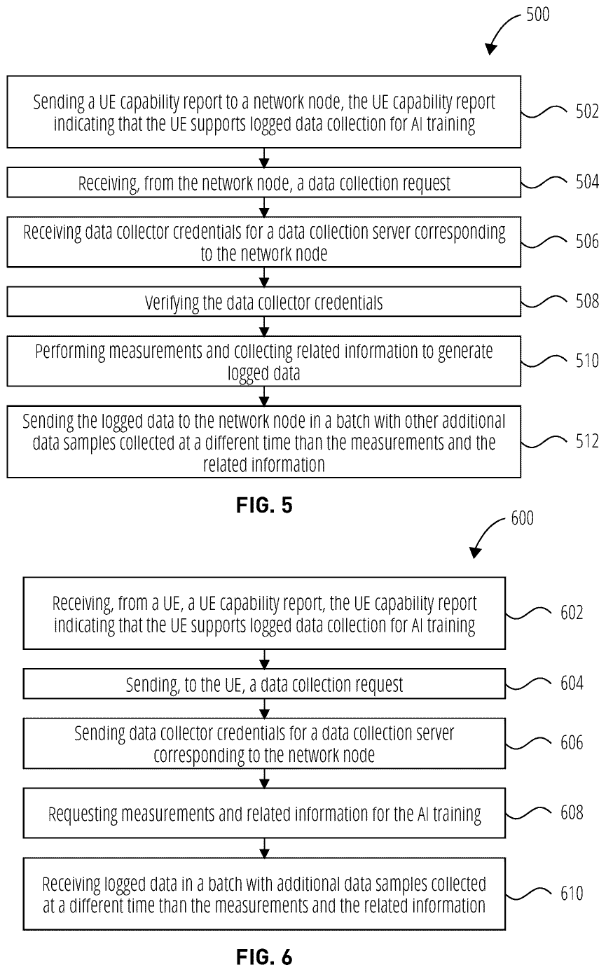

FIG. 6 illustrates a flow chart of a method 600 for a network node, according to embodiments herein. The method 600 includes receiving 602, from a UE, a UE capability report, the UE capability report indicating that the UE supports logged data collection for AI training. The method 600 further includes sending 604, to the UE, a data collection request. The method 600 further includes sending 606 data collector credentials for a data collection server corresponding to the network node. The method 600 further includes requesting 608 measurements and related information for the AI training. The method 600 further includes receiving 610 logged data in a batch with additional data samples collected at a different time than the measurements and the related information.

In some embodiments of the method 600, the data collector credentials comprise an identity of the data collector, a verification key, and a timestamp.

In some embodiments of the method 600, the UE capability report indicates one or more sub-features that the UE supports, wherein the sub-features comprise at least one of data collection for CSI, data collection for BM, data collection for positioning, a number of ports, or a sample size.

In some embodiments, the method 600 further comprises receiving, from the UE, a response to the data collection request that indicates whether the UE accepts or rejects the data collection request.

In some embodiments of the method 600, the logged data comprises coupled reports that establish linkage between measurement sets.

In some embodiments, the method 600 further comprises sending a data collection configuration, wherein the data collection configuration includes data collection conditions indicate that the UE is to perform the measurements and collect the related information based on at least one of a signal to noise ratio, a time, or a geographical area.

In some embodiments of the method 600, the logged data is received from a server after a preconfigured amount of time has elapsed since the logged data was sent to the server.

In some embodiments, the method 600 further comprises receiving a data quality indicator for the logged data.

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein).

These instructions may be, for example, located in the processor and/or on a memory of the base station (such as a memory 822 of a network device 818 that is a base station, as described herein).

### Training Data Composition

For beam management using spatial domain prediction, a training data set may include multiple samples. Each sample includes an input part and an output part. For example, the input part comprises eight RSRP measurements from SSBs or eight CSI resources, and the output part comprises four beam IDs that are each associated with a CSI-RS resource. In another example, the input part comprises eight RSRP measurements from SSBs or eight CSI resources, and the output part comprises four RSRPs that are each associated with a CSI-RS resource. The output values may be formulated as relative values (e.g., the strongest RSRP is at 0 dB, the weakest RSRP is −40 dB, etc.).

For beam management using time domain prediction, a training data set may include multiple samples. Each sample may include a sequence of input parts and an output part. In a first example, a sequence of four input parts may be provided, wherein each input part is for a time instance. One input may comprise eight RSRP measurements from SSBs or eight CSI resources, and the output part may comprises four beam IDs that are each associated with a CSI-RS resource for a future time instance.

In another example, the input part may comprise eight RSRP measurements from SSBs or eight CSI resources. For example, Table 1 shows four time instances (Instance-1, Instance-2, Instance-3, and Instance-4), wherein each time instance includes training data for eight inputs (Input-1, Input-2, . . . , Input-8). The output part may comprise four RSRPs that are each associated with a CSI-RS resource for a future time instance. The output values may be formulated as relative values (e.g., the strongest RSRP is at 0 dB, the weakest RSRP is −40 dB, etc.).

TABLE 1

| Instance 1 | Instance 2 | Instance 3 | Instance 4 |
|---|---|---|---|
| Input-1 | Input-1 | Input-1 | Input-1 |
| Input-2 | Input-2 | Input-2 | Input-2 |
| Input-3 | Input-3 | Input-3 | Input-3 |
| Input-4 | Input-4 | Input-4 | Input-4 |
| Input-5 | Input-5 | Input-5 | Input-5 |
| Input-6 | Input-6 | Input-6 | Input-6 |
| Input-7 | Input-7 | Input-7 | Input-7 |
| Input-8 | Input-8 | Input-8 | Input-8 |

### Training Data Overhead Reduction

In certain embodiments, the overhead of the training data can be represented as (N1×M1×B1)+(N2×M2×B2) bits, where N1 is the number of time instances, M1 is the number of inputs per time instance, B1 is the number of bits for representing the RSRP for each input, N2 is the number of prediction time instances (e.g., for beam management using spatial domain prediction, N2=1, for beam management using time domain prediction, N2 can be 1 or more), M2 is the number output beam ID/RSRP., and B2 is the number of bits for representing the RSRP for each output (in case the output is not in the form of beam ID).

For the output, if a beam ID is used, then the bitmap or combinatorial index may be used to indicate the beam ID, which can compare favorably against “M2×N2” bits. However, with N1 at 100-300 time instances, the size of the training data set cannot be considered small.

A number of ways may be used to compress the training dataset. If carried over a data plane, a source encoding algorithm may be applied to the training data. However, if the training data set is provided through RRC signaling or MAC CE to the network, then overhead reduction may be provided, according to embodiments disclosed herein. Even though beam reporting (i.e., from the UE to the network) and training data set provision for performance monitoring (i.e., from the network to the UE) are different, the overhead reduction schemes for them may be leveraged for each other.

Examples for overhead reduction schemes, including the selection and indication of strong beams, the selected and indication of the reference beams (strongest beams), the quantization scheme, quantizer design may be found, for example, in U.S. Provisional Application No. 63/501,875, which is hereby incorporated by reference herein. A first set of downlink reference signals may be shared for AI/ML inference and/or data collection and/or performance monitoring.

A second set of downlink reference signals may be shared for AI/ML inference and/or data collection and/or performance monitoring. AI/ML inference and/or data collection and/or performance monitoring may have its separate first set of downlink reference signals; AI/ML inference and/or data collection and/or performance monitoring may have its separate second set of downlink reference signals.

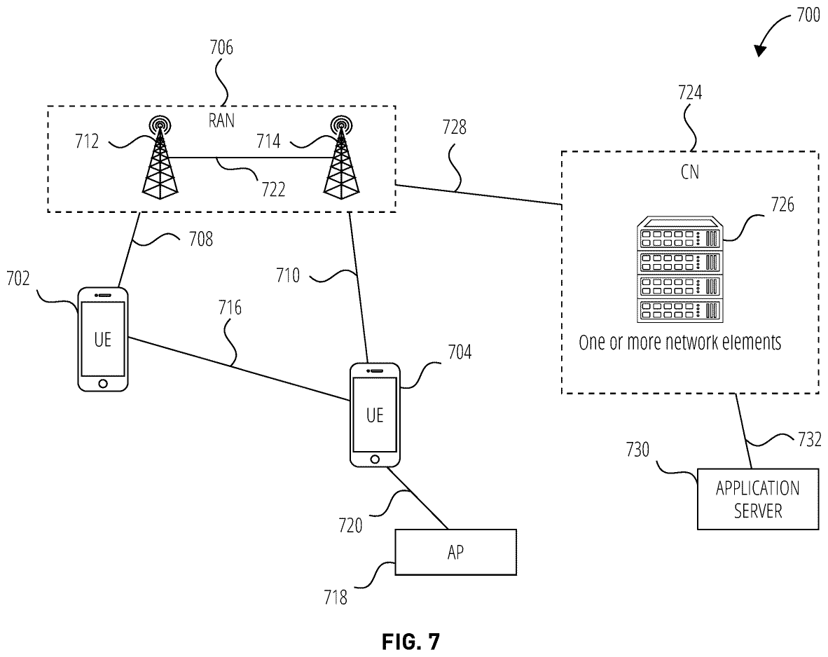

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

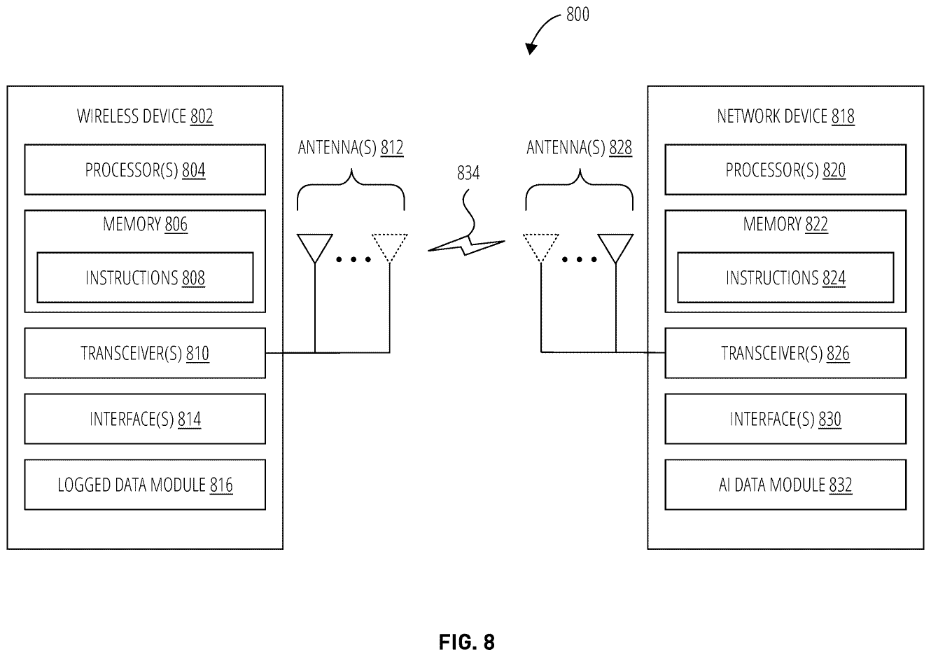

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a logged data module 816. The logged data module 816 may be implemented via hardware, software, or combinations thereof. For example, the logged data module 816 may be implemented as a processor, circuit, and/or instructions 808 stored in the memory 806 and executed by the processor(s) 804. In some examples, the logged data module 816 may be integrated within the processor(s) 804 and/or the transceiver(s) 810. For example, the logged data module 816 may be implemented by a combination of software components (e.g., executed by a DSP or a general processor) and hardware components (e.g., logic gates and circuitry) within the processor(s) 804 or the transceiver(s) 810.

The logged data module 816 may be used for various aspects of the present disclosure, for example, aspects of FIGS. 1-7. The logged data module 816 is configured to generate a UE capability report, verify data collector credentials, and generate and send logged data.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include an AI data module 832. The AI data module 832 may be implemented via hardware, software, or combinations thereof. For example, the AI data module 832 may be implemented as a processor, circuit, and/or instructions 824 stored in the memory 822 and executed by the processor(s) 820. In some examples, the AI data module 832 may be integrated within the processor(s) 820 and/or the transceiver(s) 826. For example, the AI data module 832 may be implemented by a combination of software components (e.g., executed by a DSP or a general processor) and hardware components (e.g., logic gates and circuitry) within the processor(s) 820 or the transceiver(s) 826.

The AI data module 832 may be used for various aspects of the present disclosure, for example, aspects of FIGS. 1-7. The AI data module 832 is configured to provide a UE with data collector credentials and configure data collection conditions, measurement signals, report format, etc.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for wireless communication by a user equipment (UE), the method comprising:
sending a UE capability report to a network node, the UE capability report indicating that the UE supports logged data collection for artificial intelligence (AI) training;
receiving, from the network node, a data collection request;
receiving data collector credentials for a data collection server corresponding to the network node;
verifying the data collector credentials;
performing measurements and collecting related information to generate logged data; and
sending the logged data to the network node.

2. The method of claim 1, wherein to verify the data collector credentials, the method further comprises sending the data collector credentials to a data collector credentials verifier.

3. The method of claim 1, wherein the data collector credentials comprise an identity of the data collector, a verification key, and a timestamp.

4. The method of claim 1, wherein the UE capability report indicates one or more sub-features that the UE supports, wherein the sub-features comprise at least one of data collection for channel state information (CSI), data collection for beam management (BM), data collection for positioning, a number of ports, or a sample size.

5. The method of claim 1, further comprising sending, to the network node, a response to the data collection request that indicates whether the UE accepts or rejects the data collection request.

6. The method of claim 1, wherein the logged data comprises coupled reports that establish linkage between measurement sets.

7. The method of claim 1, further comprising receiving a data collection configuration from the network node, wherein the data collection configuration includes data collection conditions indicate that the UE is to perform the measurements and collect the related information based on at least one of a signal to noise ratio, a time, or a geographical area.

8. The method of claim 1, further comprising sending the logged data to a server, wherein sending the logged data to the network node comprises sending a uniform resource locator (URL) corresponding to a location of the logged data, wherein the URL is sent after a preconfigured amount of time has elapsed since the logged data was sent to the server.

9. The method of claim 1, further comprising sending a data quality indicator for the logged data.

10. The method of claim 1, wherein the logged data is sent to the network node in a batch with other additional data samples collected at a different time than the measurements and the related information.

11. A method for wireless communication by a network node, the method comprising:
receiving, from a user equipment (UE), a UE capability report, the UE capability report indicating that the UE supports logged data collection for artificial intelligence (AI) training;
sending, to the UE, a data collection request;
sending data collector credentials for a data collection server corresponding to the network node;
requesting measurements and related information for the AI training; and
receiving logged data in a batch with additional data samples collected at a different time than the measurements and the related information.

12. The method of claim 11, wherein the data collector credentials comprise an identity of the data collector, a verification key, and a timestamp.

13. The method of claim 11, wherein the UE capability report indicates one or more sub-features that the UE supports, wherein the sub-features comprise at least one of data collection for channel state information (CSI), data collection for beam management (BM), data collection for positioning, a number of ports, or a sample size.

14. The method of claim 11, further comprising receiving, from the UE, a response to the data collection request that indicates whether the UE accepts or rejects the data collection request.

15. The method of claim 11, wherein the logged data comprises coupled reports that establish linkage between measurement sets.

16. The method of claim 11, further comprising sending a data collection configuration, wherein the data collection configuration includes data collection conditions indicate that the UE is to perform the measurements and collect the related information based on at least one of a signal to noise ratio, a time, or a geographical area.

17. The method of claim 11, wherein the logged data is received from a server after a preconfigured amount of time has elapsed since the logged data was sent to the server.

18. The method of claim 11, further comprising receiving a data quality indicator for the logged data.

19-21. (canceled)
